(19) United States
(12) Patent Application Publication
(10) Pub. No.: US 2026/0011021 A1
(43) Pub. Date: Jan. 8, 2026

(54) REAL TIME SIMULTANEOUS LOCALIZATION AND MAPPING SYSTEM BASED ON IMPLICIT REPRESENTATION

(71) Applicant: ZHEJIANG UNIVERSITY, Hangzhou, ZHEJIANG PROVINCE (CN)

(72) Inventors: YUE WANG, HANGZHOU, ZHEJIANG PROVINCE (CN); YUNXUAN MAO, HANGZHOU, ZHEJIANG PROVINCE (CN); XUAN YU, HANGZHOU, ZHEJIANG PROVINCE (CN); YIYI LIAO, HANGZHOU, ZHEJIANG PROVINCE (CN); RONG XIONG, HANGZHOU, ZHEJIANG PROVINCE (CN)

(21) Appl. No.: 19/124,947

(22) PCT Filed: Jul. 11, 2024
(86) PCT No.: PCT/CN2024/104927

§ 371 Date: Apr. 28, 2025

(30) Foreign Application Priority Data
Aug. 15, 2023 (CN) 202311026128.0

(51) Int. Cl. G06T 7/246; G06T 7/579

(52) U.S. Cl. CPC G06T 7/248; G06T 7/579; G06T 2207/10016; G06T 2207/10024; G06T 2207/10028; G06T 2207/20072; G06T 2207/20081; G06T 2207/20084; G06T 2207/30244

(57) ABSTRACT

The present invention is a real time simultaneous localization and mapping system based on implicit representation, which includes a multi-threaded localization and mapping module, wherein the multi-threaded localization and mapping module includes a camera tracking thread, a local mapping thread, and a global mapping thread which are parallel; the camera tracking thread is configured to track camera poses in real time in a feature point extraction and matching manner according to color-depth video frames collected in real time; the local mapping thread is configured to construct local maps in real time in an implicit representation manner based on the color-depth video frames and the camera poses; and the global mapping thread is configured to stitch and update all the local maps in real time to obtain a complete global map. This system simultaneously leverages the characteristic of accurate localization of traditional simultaneous localization and mapping methods and the characteristic of obtaining high-precision maps of implicit representation methods, so as to realize accurate localization and obtain the corresponding high-precision map at the same time.

### TECHNICAL FIELD

The present invention belongs to the technical field of visual simultaneous localization and mapping, and specifically relates to a real time simultaneous localization and mapping system based on implicit representation.

### BACKGROUND TECHNOLOGY

Visual simultaneous localization and mapping (vSLAM) is a very fundamental yet challenging computer vision task. It can enable device navigation and path planning by creating a map and simultaneously determining its own position in an unknown environment. In both domestic and international research, the simultaneous localization and mapping system has been widely applied in a plurality of fields such as autonomous driving and robot operation.

In recent years, many simultaneous localization and mapping systems have emerged. According to different technical solutions, these systems may be classified into traditional simultaneous localization and mapping systems and deep learning-based simultaneous localization and mapping systems. The traditional simultaneous localization and mapping systems mainly rely on geometric information of sensor data for motion estimation and map construction. They use traditional computer vision algorithms, such as feature point extraction and matching, an optical flow method, and stereo matching, to realize the motion estimation and the map construction. There are many representative works in the traditional simultaneous localization and mapping systems. In 2011, Richard Newcombe et al. proposed DTAM. In this paper, the authors presented a vision-based simultaneous localization and mapping system that may generate a dense three-dimensional map in real time from a continuous sequence of images captured by a camera, and simultaneously track a position and pose of the camera, achieving real time localization and mapping. This method adopts an optimization-based framework, converting sparse feature point matching into dense pixel matching, thereby improving the accuracy and efficiency of tracking and mapping. In 2015, Raúl Mur-Artal proposed ORB-SLAM. In this paper, the author presented a simultaneous localization and mapping system based on ORB feature points. Through extraction and matching of the ORB feature points, real time camera localization and three-dimensional map construction are realized. This method adopts a sliding-window-based optimization framework, which may effectively handle estimation errors of camera poses and map, and have high accuracy and robustness in a plurality of scenarios.

With development of deep learning, many deep learning-based simultaneous localization and mapping systems have emerged. These systems use deep learning models to learn processes of motion estimation and map construction, directly learning from an image or light detection and ranging data. In 2020, R. Li et al. proposed a DeepSLAM system. The DeepSLAM system adopted an unsupervised training method, which does not require use of labeled data and may be trained on a large amount of unlabeled data, thus achieving more efficient and flexible deep learning feature extraction and depth estimation. The traditional simultaneous localization and mapping systems may provide relatively accurate localization accuracy, but they may only output point-cloud maps lacking geometric relationships, which cannot meet interaction needs of robots. The deep learning-based simultaneous localization and mapping systems may output dense maps, but they also have problems such as a slow training speed and poor generalization ability.

With development of implicit representation, many simultaneous localization and mapping systems that use the implicit representation as maps have emerged. The implicit representation maps are characterized by their light weight, ability to render high-precision images and extract high-precision surfaces. It is a map representation method with geometric continuity and is very suitable for mapping tasks. Z. Zhu et al. proposed NICE-SLAM. In this paper, the authors presented a method that simultaneously uses implicit representation maps for localization and reconstruction. This system may extract high-quality, interactive and dense grids for a downstream task. However, the method of using implicit representation for localization lacks the global optimization and loop closure detections of traditional simultaneous localization and mapping system, resulting in relatively low localization accuracy of this method.

### SUMMARY OF THE INVENTION

To address the technical problems that the traditional simultaneous localization and mapping methods cannot obtain high-precision maps and the implicit representation methods cannot realize accurate localization, embodiments provide a real time simultaneous localization and mapping system based on implicit representation. This system simultaneously leverages the characteristic of accurate localization of traditional simultaneous localization and mapping methods and the characteristic of obtaining high-precision maps of implicit representation methods, so as to realize accurate localization and obtain the corresponding high-precision map at the same time.

To realize the above-mentioned invention objects, an embodiment provides a real time simultaneous localization and mapping system based on implicit representation, comprising a multi-threaded localization and mapping module, wherein the multi-threaded localization and mapping module comprises a camera tracking thread, a local mapping thread, and a global mapping thread which are parallel;
the camera tracking thread is configured to track camera poses in real time in a feature points extraction and matching manner according to color-depth video frames collected in real time;
the local mapping thread is configured to construct real time local maps in an implicit representation manner based on the color-depth video frames and the camera poses;
the global mapping thread is configured to stitch and update all the local maps in real time to obtain a complete global map; and
the global map and local map obtained by the system realizes rendering of high-resolution color-depth images and extraction of high-precision surfaces.

Preferably, the camera tracking thread comprises a key frame selection unit, a local optimization unit, a loop closure detection unit, and a global optimization unit;
the key frame selection unit is configured to extract ORB features from the color-depth video frames, then select key frames by counting the number of the ORB features, and construct an essential graph based on the key frames, wherein in the essential graph, the key frames serve as graph nodes, and the edges among the graph nodes are established according to co-visibility degrees, wherein the co-visibility degrees are matching degrees among the ORB features of two key frames;
the local optimization unit is configured to locally optimize relative poses of local key frames corresponding to a current moment according to the essential graph;
the loop closure detection unit is configured to monitor the ORB features of the color-depth video frames in real time and detect whether a loop closure occurs in the color-depth video frames according to the number of the ORB features; and
the global optimization unit is configured to globally optimize relative poses of key frames in a current essential graph when the loop closure occurs.

Preferably, in the local optimization unit, locally optimizing relative poses of local key frames corresponding to a current moment according to the essential graph comprises:
for the current moment, according to the essential graph at the current moment, screening key frames corresponding to graph nodes with co-visibility degrees greater than a first co-visibility degree threshold as local key frames; for each local key frame, utilizing key frames that are connected to each local key frame and have co-visibility degrees greater than the first co-visibility degree threshold to locally optimize the relative poses of the local key frames; and
a process of optimizing the relative poses is to determine the relative poses of the local key frames according to relative poses of matched ORB features of two key frames.

Preferably, in the loop closure detection unit, detecting whether a loop closure occurs in the color-depth video frames according to the number of the ORB features comprises:
introducing a frame number threshold; and when it is determined that the number of historical color-depth video frames exceeds the frame number threshold and the number of matched ORB features between a current color-depth video frame and a previous color-depth video frame reaches a feature number threshold, considering that the loop closure occurs in the color-depth video frames.

Preferably, in the global optimization unit, globally optimizing poses of key frames in a current essential graph comprises:
for each key frame, the relative pose of the key frame is determined according to relative poses between matched ORB features of the key frame and all adjacent key frames thereof to realize global optimization of the key frame.

Preferably, the local mapping thread comprises a local map initialization unit and a local map training unit;
the local map initialization unit is configured to initialize a new local map when it is determined according to the essential graph that a co-visibility degree between a first key frame of a current local map and a current key frame is less than a second co-visibility degree threshold, wherein the local map is an incremental implicit representation network; and
the local map training unit is configured to use the local key frames and the corresponding relative poses output by the local optimization unit as an input of the incremental implicit representation network, and realize the training and optimization of the local map through training of the incremental implicit representation network.

Preferably, the incremental implicit representation network comprises a feature grid, trilinear interpolation, and a feature decoder, wherein the feature network adopts an octree structure, and features are stored at corner points of different levels of the octree, and a specific construction process of the feature network is as follows: a depth image corresponding to the local key frames is converted into a point cloud, an octree-structured network is generated according to the point cloud, a camera ray of the color image corresponding to the local key frame under the relative pose is determined according to the relative pose, the camera ray is emitted to the grid and intersects with the grid, and the features are stored at the corner points of the grid, and the features are optimized during training;
the trilinear interpolation is configured to, when querying a sampling point, perform the trilinear interpolation on the features on the corner points of a grid to which the sampling point belongs based on the feature grid, and fuse interpolation features of a plurality of levels to obtain a feature vector of the sampling point; and
the feature decoder comprises a color decoder and a geometric decoder, which are configured to perform color decoding and geometric decoding on the feature vector of the sampling point, respectively, to obtain color information and geometric information.

Preferably, in the local map training unit, a process of training the incremental implicit representation network is as follows:
the color information and the geometric information are rendered in a volume rendering manner to obtain a rendered color image and a rendered depth image, a photometric loss is constructed based on a difference between the rendered color image and an input color image, and a depth loss is constructed based on a difference between the rendered depth image and an input depth image, and features of the feature grid and parameters of the feature decoder in the incremental implicit representation network are optimized according to the photometric loss and the depth loss.

Preferably, the global mapping thread comprises a multi-map stitching unit and a global map updating unit.
the multi-map stitching unit is configured to stitch the local maps generated by the local mapping thread in real time to obtain a global map; and
the global map updating unit is configured to update all the local maps that make up the global map according to globally optimized relative poses after the global optimization by the global optimization unit, and then update the global map.

Preferably, the system further comprises an image rendering module based on uncertainty, wherein the image rendering module based on uncertainty is configured to perform rendering according to the geometric information output by a plurality of local maps, which specifically comprises: in each local map, occupancy is utilized to represent the geometric information; after occupancy p of each pixel point is determined, an occupancy variance var of each pixel point is calculated by a variance formula of the Bernoulli distribution var=p(1−p); and a volume rendering method is utilized to calculate uncertainty of each pixel point in a rendered image according to the occupancy variance var of each pixel point, and then overall uncertainty of each rendered image is obtained, and a rendered image with a lowest uncertainty is selected as a final output according to the overall uncertainty of the rendered images corresponding to each local map.

Compared with the prior art, the present invention has at least the following beneficial effects:

Through the three parallel threads, namely the camera tracking thread, the local mapping thread, and the global mapping thread, while tracking and localization the camera poses in real time, the local mapping and global mapping are carried out to realize accurate localization and obtain the corresponding high-precision map at the same time.

### BRIEF DESCRIPTION OF THE DRAWINGS

In order to more clearly illustrate technical schemes in the embodiments of the present invention or in the prior art, the following will briefly introduce drawings that need to be used in description of the embodiments or the prior art. Obviously, the drawings described below are only some embodiments of the present invention. For those of ordinary skill in the art, without creative efforts, other drawings can also be obtained according to these drawings.

FIG. 1 is a schematic structural diagram of a real-time simultaneous localization and mapping system based on implicit representation provided in an embodiment;

FIG. 2 is a schematic structural diagram of a multi-threaded localization and mapping module provided in an embodiment; and

FIG. 3 is a training flowchart of an incremental implicit representation network corresponding to local maps provided in an embodiment.

### DETAILED DESCRIPTION OF THE EMBODIMENTS

In order to make the objects, technical schemes and advantages of the present invention more clearly understood, the present invention is further described in detail below in combination with accompanying drawings and embodiments. It should be understood that the specific embodiments described herein are only used to explain the present invention, and do not limit the protection scope of the present invention.

In order to simultaneously leverage the characteristic of accurate localization of traditional simultaneous localization and mapping systems and the characteristic of obtaining high-precision maps of implicit representation methods, and to address technical problems that traditional methods cannot obtain high-precision maps and the implicit representation methods cannot realize accurate localization, the embodiments of the present invention provide a real time simultaneous localization and mapping system based on implicit representation to realize accurate localization and obtain corresponding high-precision maps at the same time.

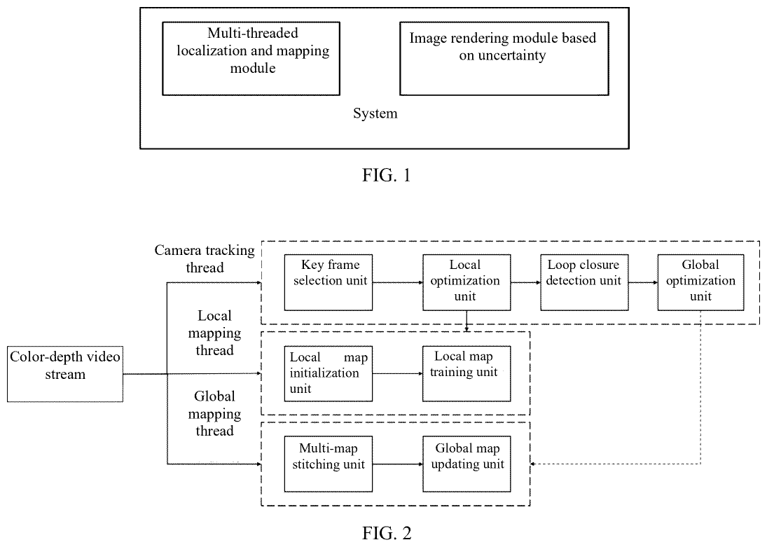

As shown in FIG. 1, the real time simultaneous localization and mapping system based on implicit representation provided in an embodiment comprises two modules: a multi-threaded localization and mapping module, and an image rendering module based on uncertainty. To enhance real time performance, the multi-threaded localization (camera pose or posture tracking) and mapping module is divided into three threads to run simultaneously, wherein the localization corresponds to a camera tracking thread, and the mapping is divided into two threads: a local mapping thread and a global mapping thread. In the camera tracking thread, a feature point extraction and matching method is utilized to track a relative pose of a camera. During a tracking process, the system has multiple optimization strategies including local optimization, global optimization, and loop closure detection to ensure accuracy of tracking. Its input is color-depth images, and its output is a relative pose of each frame of the images. In the local mapping thread, an implicit representation method is adopted to construct a local map where the current camera is located by using the camera poses obtained from the tracking thread and the color-depth images, so as to obtain a local implicit scene map. The local mapping process corresponds to a local optimization in the pose tracking thread. In the global mapping thread, the local maps obtained from the local mapping thread are stitched or spliced and updated to obtain a complete global map. The following is a detailed description of each thread.

In the embodiment, the camera tracking thread is configured to track camera poses in real time in a feature point extraction and matching manner according to color-depth video frames inputted in real time. As shown in FIG. 2, the camera tracking thread comprises a key frame selection unit, a local optimization unit, a loop closure detection unit, and a global optimization unit. Specifically, to realize real time pose tracking of an input color-depth video stream, a method of extracting ORB features and matching these features is utilized to track each frame of images.

In order to reduce a computational load and maintain consistency of tracking, a key frame selection unit is introduced. The key frame selection unit is configured to extract the ORB features from the color-depth video frames and then select key frames by counting the number of the ORB features. Specifically, when the number of ORB features is greater than a set threshold, the corresponding color-depth video frames are regarded as key frames. After obtaining the key frames, an essential graph is also constructed and updated in real time according to the key frames. Specifically, in the essential graph, the key frames serve as graph nodes, and edges among the graph nodes are established based on co-visibility degrees, wherein the co-visibility degree refers to a matching degree between ORB features of two key frames, the matching degree is characterized by a matching value between the features, and the matching value serves as a co-visibility degree value, which is also the weight value of the edge. The larger the matching value, the greater the weight value of the corresponding edge.

The local optimization unit is configured to locally optimize relative poses of local key frames corresponding to a current moment according to the essential graph. Specifically, for the current moment, according to the essential graph at the current moment, screening key frames corresponding to graph nodes with co-visibility degrees greater than a first co-visibility degree threshold as local key frames; and for each local key frame, utilizing key frames that are connected to each local key frame and have co-visibility degrees greater than the first co-visibility degree threshold to locally optimize the relative poses of the local key frames, wherein a process of optimizing the relative poses is to determine the relative poses of the local key frames according to relative poses of matched ORB features of two key frames. In this way, the poses of local key frames can be continuously optimized through the method of graph optimization.

Long-distance camera tracking often leads to cumulative errors. In order to eliminate these cumulative errors, a loop closure detection unit and a global optimization unit are added to the camera tracking thread of this system, wherein the loop closure detection unit is configured to monitor the ORB features of the color-depth video frames in real time and detect whether a loop closure occurs in the color-depth video frames according to the number of the ORB features. Specifically, a frame number threshold is introduced; and when it is determined that the number of historical color-depth video frames exceeds the frame number threshold and the number of matched ORB features between a current color-depth video frame and a previous color-depth video frame reaches a feature number threshold, considering that the loop closure occurs in the color-depth video frames. The frame number threshold and the feature number threshold are set according to an actual situation.

The global optimization unit is configured to globally optimize relative poses of key frames in a current essential graph when the loop closure occurs. Specifically, for each key frame, the relative pose of the key frame is determined according to relative poses between matched ORB features of the key frame and all adjacent key frames thereof to realize global optimization of the key frame. In this way, the cumulative errors can be eliminated.

In the embodiment, the local mapping thread is configured to construct real time local maps in an implicit representation manner based on the color-depth video frames and the camera poses. As shown in FIG. 2, the local mapping thread comprises a local map initialization unit and a local map training unit, wherein the local map is an incremental implicit representation network.

The local map initialization unit is responsible for determining whether a new local map needs to be established for the current map. The basis for its determination is the local optimization unit of the camera tracking thread. Specifically, it is configured to initialize a new local map when it is determined according to the essential graph that a co-visibility degree between a first key frame of a current local map and a current key frame is less than a second co-visibility degree threshold.

The local map training unit is configured to use the local key frames and the corresponding relative poses output by the local optimization unit as an input of the incremental implicit representation network, use geometric information and color information of target sampling points as an output. The training and optimization of the local map through is achieved by training the incremental implicit representation network.

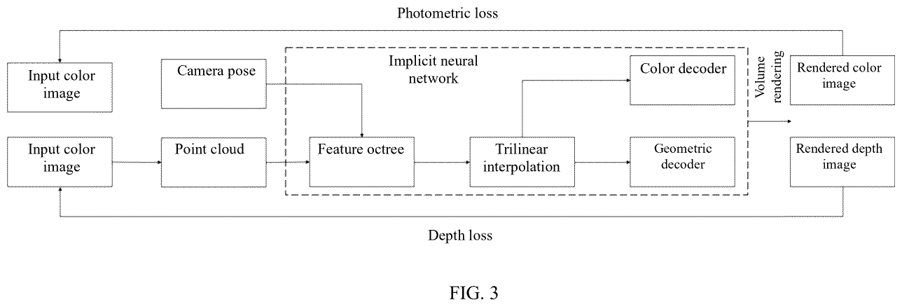

Specifically, as shown in FIG. 3, the incremental implicit representation network comprises a feature grid, trilinear interpolation, and a feature decoder, wherein the feature network adopts an octree structure, and features are stored at corner points of different levels of the octree. The specific construction process of the feature network is as follows: a depth image corresponding to the local key frames is converted into a point cloud, an octree-structured network is generated according to the point cloud, a camera ray of the color image corresponding to the local key frame under the relative pose is determined according to the relative pose, the camera ray is emitted to the grid and intersects with the grid, and the features are stored at the corner points of the grid, and the features are optimized during training; and the trilinear interpolation is configured to, when querying a sampling point, perform the trilinear interpolation on the features on the corner points of a grid to which the sampling point belongs based on the feature grid, and fuse interpolation features of a plurality of levels to obtain a feature vector of the sampling point. The feature decoder includes a color decoder and a geometric decoder, which are used to perform color decoding and geometric decoding on the feature vector of the sampling point to obtain color information and geometric information, respectively.

The incremental implicit representation network may render images through a method of volume rendering. For a given viewing angle, a depth and color of each pixel are rendered by using geometric information and color information of the sampling points on a camera ray emitted from each pixel. A process of training the incremental implicit representation network is as follows: the color information and the geometric information are rendered in a volume rendering manner to obtain a rendered color image and a rendered depth image, a photometric loss is constructed based on a difference between the rendered color image and an input color image, and a depth loss is constructed based on a difference between the rendered depth image and an input depth image, and features of the feature grid and parameters of the feature decoder in the incremental implicit representation network are optimized according to the photometric loss and the depth loss.

In the embodiment, the global mapping thread is configured to stitch and update all the local maps in real time to obtain a complete global map. As shown in FIG. 2, the global mapping thread comprises a multi-map stitching unit and a global map updating unit. Since the local mapping thread has trained a plurality of local maps, the multi-map stitching unit is configured to stitch the local maps generated by the local mapping thread in real time to obtain a global map. After the global optimization occurs, the camera poses of each local map changes, and the global map updating unit is configured to update all the local maps that make up the global map according to globally optimized relative poses, and then update the global map. Specifically, the obtained global map and local maps can realize rendering of high-resolution color-depth images and extraction of high-precision surfaces.

In the embodiment, the image rendering module based on uncertainty is responsible for rendering according to the geometric information output by the plurality of local maps, and selecting a highest-quality map from the images rendered by the plurality of local maps. In the implicit representation network of the local maps, the present invention utilizes an occupancy rate to represent the geometric information, wherein the occupancy rate p is a real number within an interval [0, 1], representing a probability of the point being occupied. An occupancy rate of 0 represents that the point is unoccupied, while an occupancy rate of 1 represents that the point is occupied. A distribution of the occupancy rate follows the Bernoulli distribution. Therefore, the variance of the occupancy rate for each pixel may be calculated by using a variance formula of the Bernoulli distribution, which is var=p(1−p). Then, through the volume rendering method, uncertainty of each pixel in the rendered image may be calculated according to the occupancy rate variance var of each pixel point, and further, overall uncertainty of each rendered image may be obtained. Finally, according to the overall uncertainty of the rendered images corresponding to each local map, an image with the lowest overall uncertainty is selected as a rendered image output of a final model.

The real time simultaneous localization and mapping system based on implicit representation provided in the above embodiment quickly and accurately completes localization and mapping tasks simultaneously, and has the following effects:

1. High-precision tracking. This system tracks the inputted color-depth video stream, estimates the high-precision camera pose for each frame of the image, and selects key frames at the same time. During the tracking process, this system simultaneously adopts three optimization methods, namely the local optimization, global optimization, and loop closure detection, to optimize the camera poses, ensuring accurate tracking and localization even in long-distance tracking tasks.

2. High-precision mapping. The mapping process of this system is divided into two parts: local mapping and global mapping. Among them, the local mapping corresponds to the local optimization part of high-precision tracking. The local mapping maintains a plurality of local maps and optimizes the local map currently being optimized to ensure the accuracy of the local map. The global mapping stitches or splices the plurality of local maps. After a loop closure or global optimization occurs during the tracking process, it quickly adjusts the relative positions of the local maps to maintain the accuracy of the global map.

3. High-precision image rendering and grid extraction. Benefiting from the advantages of the implicit representation method, the implicit map constructed by this system can render images from any viewing angle and select the images by using uncertainty to obtain high-quality color images and depth images. At the same time, the implicit map of this system can also extract dense grids that can be used for interaction.

4. Real-time performance. This system can perform simultaneous localization and mapping at a frequency of 10 Hz. This frequency can be applied to most practical task scenarios and meet the real time requirements of these scenarios.

The specific embodiments described above have elaborated on the technical schemes and beneficial effects of the present invention. It should be understood that the above-mentioned contents are only the most preferred embodiments of the present invention and are not intended to limit the present invention. Any modification, supplement, equivalent replacement, etc. made within the scope of the principles of the present invention shall all be included in the protection scope of the present invention.

1. A real time simultaneous localization and mapping system based on implicit representation, comprising a multi-threaded localization and mapping module, wherein the multi-threaded localization and mapping module comprises a camera tracking thread, a local mapping thread, and a global mapping thread which are parallel;
the camera tracking thread is configured to track camera poses in real time in a feature point extraction and matching manner according to color-depth video frames collected in real time;
wherein the camera tracking thread comprises a key frame selection unit, a local optimization unit, a loop closure detection unit, and a global optimization unit; the key frame selection unit is configured to extract ORB (Oriented FAST and Rotated BRIEF) features from the color-depth video frames, then select key frames by counting the number of the ORB features, and construct an essential graph based on the key frames, wherein in the essential graph, the key frames serve as graph nodes, and the edges among the graph nodes are established according to co-visibility degrees, wherein the co-visibility degrees are matching degrees among the ORB features of two key frames; the local optimization unit is configured to locally optimize relative poses of local key frames corresponding to a current moment according to the essential graph; the loop closure detection unit is configured to monitor the ORB features of the color-depth video frames in real time and detect whether a loop closure occurs in the color-depth video frames according to the number of the ORB features; and the global optimization unit is configured to globally optimize relative poses of key frames in a current essential graph when the loop closure occurs;
the local mapping thread is configured to construct local maps in real time in an implicit representation manner based on the color-depth video frames and the camera poses; wherein the local mapping thread comprises a local map initialization unit and a local map training unit; the local map initialization unit is configured to initialize a new local map when it is determined according to the essential graph that a co-visibility degree between a first key frame of a current local map and a current key frame is less than a second co-visibility degree threshold, wherein the local map is an incremental implicit representation network; and the local map training unit is configured to use the local key frames and the corresponding relative poses output by the local optimization unit as an input of the incremental implicit representation network, and realize the training and optimization of the local map through training of the incremental implicit representation network;
the global mapping thread is configured to stitch and update all the local maps in real time to obtain a complete global map; and
the global map and local map obtained by the system realizes rendering of high-resolution color-depth images and extraction of high-precision surfaces.

2. (canceled)

3. The real time simultaneous localization and mapping system based on implicit representation according to claim 1, wherein in the local optimization unit, locally optimizing relative poses of local key frames corresponding to a current moment according to the essential graph comprises:
for the current moment, according to the essential graph at the current moment, screening key frames corresponding to graph nodes with co-visibility degrees greater than a first co-visibility degree threshold as local key frames; for each local key frame, utilizing key frames that are connected to each local key frame and have co-visibility degrees greater than the first co-visibility degree threshold to locally optimize the relative poses of local key frames; and
a process of optimizing the relative poses is to determine the relative poses of the local key frames according to relative poses of matched ORB features of two key frames.

4. The real time simultaneous localization and mapping system based on implicit representation according to claim 1, wherein in the loop closure detection unit, detecting whether a loop closure occurs in the color-depth video frames according to the number of the ORB features comprises:
introducing a frame number threshold; and when it is determined that the number of historical color-depth video frames exceeds the frame number threshold and the number of matched ORB features between a current color-depth video frame and a previous color-depth video frame reaches a feature number threshold, considering that the loop closure occurs in the color-depth video frames.

5. The real time simultaneous localization and mapping system based on implicit representation according to claim 1, wherein in the global optimization unit, globally optimizing poses of key frames in a current essential graph comprises:
for each key frame, the relative pose of the key frame is determined according to relative poses between matched ORB features of the key frame and all adjacent key frames thereof to realize global optimization of the key frame.

6. (canceled)

7. The real time simultaneous localization and mapping system based on implicit representation according to claim 16, wherein the incremental implicit representation network comprises a feature grid, trilinear interpolation, and a feature decoder, wherein the feature network adopts an octree structure, and features are stored at corner points of different levels of the octree, and a specific construction process of the feature network is as follows: a depth image corresponding to the local key frames is converted into a point cloud, an octree-structured network is generated according to the point cloud, a camera ray of the color image corresponding to the local key frame under the relative pose is determined according to the relative pose, the camera ray is emitted to the grid and intersects with the grid, and the features are stored at the corner points of the grid, and the features are optimized during training;
the trilinear interpolation is configured to, when querying a sampling point, perform the trilinear interpolation on the features on the corner points of a grid to which the sampling point belongs based on the feature grid, and fuse interpolation features of a plurality of levels to obtain a feature vector of the sampling point; and
the feature decoder comprises a color decoder and a geometric decoder, which are configured to perform color decoding and geometric decoding on the feature vector of the sampling point respectively to obtain color information and geometric information.

8. The real time simultaneous localization and mapping system based on implicit representation according to claim 1, wherein in the local map training unit, a process of training the incremental implicit representation network is as follows:
the color information and the geometric information are rendered in a volume rendering manner to obtain a rendered color image and a rendered depth image, a photometric loss is constructed based on a difference between the rendered color image and an input color image, and a depth loss is constructed based on a difference between the rendered depth image and an input depth image, and features of the feature grid and parameters of the feature decoder in the incremental implicit representation network are optimized according to the photometric loss and the depth loss.

9. The real time simultaneous localization and mapping system based on implicit representation according to claim 1, wherein the global mapping thread comprises a multi-map stitching unit and a global map updating unit.
the multi-map stitching unit is configured to stitch the local maps generated by the local mapping thread in real time to obtain a global map; and
the global map updating unit is configured to update all the local maps that make up the global map according to globally optimized relative poses after the global optimization by the global optimization unit, and then update the global map.

10. The real time simultaneous localization and mapping system based on implicit representation according to claim 1, further comprising an image rendering module based on uncertainty;
the image rendering module based on uncertainty is configured to perform rendering according to the geometric information output by a plurality of local maps, which specifically comprises: in each local map, occupancy is utilized to represent the geometric information; after occupancy p of each pixel point is determined, an occupancy variance var of each pixel point is calculated by a variance formula of the Bernoulli distribution var=p(1−p); and a volume rendering method is utilized to calculate uncertainty of each pixel point in a rendered image according to the occupancy variance var of each pixel point, and then overall uncertainty of each rendered image is obtained, and a rendered image with a lowest uncertainty is selected as a final output according to the overall uncertainty of the rendered images corresponding to each local map.
